(19) United States
(12) Patent Application Publication
(10) Pub. No.: US 2020/0410737 A1
(43) Pub. Date: Dec. 31, 2020

(54) IMAGE DISPLAY METHOD AND DEVICE APPLIED TO ELECTRONIC DEVICE, MEDIUM, AND ELECTRONIC DEVICE

(71) Applicant: BOE TECHNOLOGY GROUP CO., LTD., Beijing (CN)

(72) Inventor: Siyu ZHU, Beijing (CN)

(21) Appl. No.: 16/910,187

(22) Filed: Jun. 24, 2020

(30) Foreign Application Priority Data
Jun. 27, 2019 (CN) 201910567062.3

(51) Int. Cl. G06T 13/80; H04N 5/232; G01L 9/02

(52) U.S. Cl. CPC G06T 13/80; G01L 9/02; H04N 5/23212; H04N 5/23219

(57) ABSTRACT

An electronic device includes a display device, a camera, and a gas pressure sensor. The display device displays a target image. An example method includes: obtaining a gas pressure value through the gas pressure sensor; acquiring an image through the camera in response to a change in the gas pressure value; detecting whether the image includes a preset object; and displaying an animation effect of the target image in response to detecting the preset object in the image.

### CROSS-REFERENCE TO RELATED APPLICATION

This application is based upon, and claims the benefit of and priority to, Chinese Patent Application No. 201910567062.3, filed Jun. 27, 2019, where the contents of which are incorporated by reference in their entirety herein.

### TECHNICAL FIELD

The present disclosure relates to the field of human-computer interaction and, more particularly, to an image display method applied to an electronic device, an image display device applied to an electronic device, a computer-readable storage medium, and an electronic device.

### BACKGROUND

Electronic images include static images and dynamic images. Currently, most dynamic images are Graphics Interchange Format (GIF) dynamic images. When GIF dynamic images are read with an image tool program, consecutive image frames may be automatically loaded and displayed to present dynamic effects. Dynamic images may show richer image information than static images. However, when users watch dynamic images, they can still only passively accept the contents of the images, which lacks a sense of interaction a problem that needs to be solved urgently.

It should be noted that the information disclosed in the background section above is only used to enhance the understanding of the background of the present disclosure and therefore, may include information that does not constitute the prior art known to those of ordinary skill in the art.

### SUMMARY

The present disclosure provides an image display method applied to an electronic device, an image display device applied to an electronic device, a non-transitory computer-readable storage medium, and an electronic device.

Other features and advantages of the present disclosure will become apparent through the following detailed description, or partly learned through the practice of the present disclosure.

According to a first aspect of the present disclosure, there is provided an image display method applied to an electronic device, wherein the electronic device includes a display device, a camera, and a gas pressure sensor, and the display device displays a target image; the method includes: obtaining a gas pressure value through the gas pressure sensor; acquiring an image through the camera in response to a change in the gas pressure value; detecting whether the image includes a preset object; and displaying an animation effect of the target image in response to detecting the preset object in the image.

Optionally, the change in the gas pressure value includes the gas pressure value within a preset time period reaching a preset threshold.

Optionally, the acquiring of an image through the camera includes obtaining a gas pressure change position, and acquiring an image of the gas pressure change position through the camera.

Optionally, the acquiring of an image of the gas pressure change position through the camera includes shooting the image through the camera with the gas pressure change position as the focus.

Optionally, the camera includes a depth camera, and the shooting of the image through the camera with the gas pressure change position as the focus includes: placing the gas pressure change position in a shooting range of the depth camera; obtaining a camera coordinate of the gas pressure change position in the depth camera; adjusting a focal length of the depth camera until that a world coordinate of the gas pressure change position converted from the camera coordinate conforms to the gas pressure change position detected by the gas pressure sensor; and shooting the image through the depth camera.

Optionally, the method further includes extracting an image element from the target image, and obtaining an animation effect of the image element, thereby obtaining the animation effect of the target image.

Optionally, the extracting of an image element from the target image, and obtaining an animation effect of the image element, thereby obtaining the animation effect of the target image includes: identifying the image element in the target image based on a target detection algorithm; segmenting the image element from the target image, and storing a remaining part as a background of the target image; and obtaining the animation effect of the image element for separate storage.

Optionally, the displaying the animation effect of the target image includes: obtaining a gas pressure change position; determining a projection point of the gas pressure change position on the target image; searching for the image element within a preset range on the target image with the projection point as a center; and displaying the animation effect of the image element as searched.

Optionally, the projection point is a vertical projection point of the gas pressure change position onto the target image.

Optionally, the gas pressure sensor includes a gas pressure sensor array for detecting gas pressure values at a plurality of positions; and the obtaining the gas pressure change position includes: determining the gas pressure change position according to changes in the gas pressure values at a plurality of positions.

Optionally, the preset object includes a human mouth.

According to a second aspect of the present disclosure, there is provided an image display device applied to an electronic device, wherein the electronic device includes a display device, a camera, and a gas pressure sensor, and the display device displays a target image; the device includes: an gas pressure acquisition module configured to obtain a gas pressure value through the gas pressure sensor; an image acquisition module configured to acquire an image through the camera in response to a change in the gas pressure value; an image detection module configured to detect whether the images includes a preset object; and an animation display module configured to display an animation effect of the target image in response to detecting the preset object in the image.

Optionally, the image acquisition module is configured to acquire the image through the camera in response to that the change in the gas pressure value within a preset time period reaches a preset threshold.

Optionally, the gas pressure acquisition module is further configured to obtain a gas pressure change position, and acquire an image of the gas pressure change position through the camera.

Optionally, the image acquisition module is configured to shoot the image through the camera with the gas pressure change position as the focus.

Optionally, the camera includes a depth camera; and the image acquisition module includes: a camera coordinate acquisition unit, configured to place the gas pressure change position in a shooting range of the depth camera, and obtain a camera coordinate of the gas pressure change position in the depth camera; a world coordinate matching unit, configured to adjust a focal length of the depth camera until that a world coordinate of the gas pressure change position converted from the camera coordinate conforms to the gas pressure change position detected by the gas pressure sensor; and an image shooting unit, configured to shoot the image through the depth camera

Optionally, the image display device further includes: an animation configuration module configured to extract an image element from the target image, and obtain an animation effect of the image element, thereby obtaining the animation effect of the target image.

Optionally, the animation configuration module includes: an image element recognition unit, configured to identify the image element in the target image based on a target detection algorithm; a target image segmentation unit, configured to segment the image element from the target image, and store a remaining part as a background of the target image; and an animation effect storage unit, configured to obtain the animation effect of the image element for separate storage.

Optionally, the gas pressure acquisition module is further configured to obtain a gas pressure change position, and the animation display module is further configured to determine a projection point of the gas pressure change position on the target image; search for the image element within a preset range on the target image with the projection point as a center; and display the animation effects of the image element as searched.

Optionally, the projection point is a vertical projection point of the gas pressure change position onto the target image.

Optionally, the gas pressure sensor includes a gas pressure sensor array for detecting gas pressure values at a plurality of positions; and the gas pressure acquisition module is further configured to determine the gas pressure change position according to changes in the gas pressure values at a plurality of positions.

Optionally, the preset object includes a human mouth.

According to a third aspect of the present disclosure, there is provided a non-transitory computer-readable storage medium on which a computer program is stored, wherein any one of the above methods is implemented when the computer program is executed by a processor.

According to a fourth aspect of the present disclosure, there is provided an electronic device including: at least one hardware processor; a memory for storing executable instructions of the at least one hardware processor; a display device; a camera; and a gas pressure sensor; wherein the display device displays a target image, and the at least one hardware processor is configured to execute any one of the above image display methods by executing the executable instructions, so as to display an animation effect of the target image.

It is to be understood that both the foregoing general description and the following detailed description are exemplary and explanatory only and are not restrictive of the present disclosure.

### BRIEF DESCRIPTION OF THE DRAWINGS

The drawings herein, which are incorporated in and constitute a part of this specification, illustrate embodiments consistent with the present disclosure, and serve to explain the principles of the present disclosure together with the description. Understandably, the drawings in the following description are just some embodiments of the present disclosure. For those of ordinary skill in the art, other drawings may be obtained based on these drawings without creative efforts.

FIG. 1 shows a flowchart of an image display method applied to an electronic device in the exemplary embodiment;

FIG. 2 shows a sub-flowchart of an image display method in the exemplary embodiment;

FIG. 3 shows a structural block diagram of an image display device applied to an electronic device in the exemplary embodiment;

FIG. 4 shows a computer-readable storage medium for implementing the above method in the exemplary embodiment;

FIG. 5 shows an electronic device for implementing the above method in the exemplary embodiment; and

FIG. 6 shows another electronic device for implementing the above method in the exemplary embodiment.

### DETAILED DESCRIPTION

Example embodiments will now be described more fully with reference to the accompanying drawings. However, the example embodiments can be implemented in various forms and should not be construed as limited to the embodiments set forth herein; rather, these embodiments are provided so that this disclosure will be thorough and complete, and will fully convey the concept of the example embodiments to those skilled in the art. The described features, structures, or characteristics may be combined in one or more embodiments in any suitable manner.

The present disclosure is providing an image display method applied to an electronic device, an image display device applied to an electronic device, a non-transitory computer-readable storage medium, and an electronic device, thereby, at least to a certain extent, improving the problem of lacking a sense of interaction in the prior art.

An embodiment of the present disclosure first provides an image display method applied to an electronic device. The electronic device includes a display device, a camera, and a gas pressure sensor. The display device may be a display screen of the electronic device. The camera may be a built-in or externally connected camera of the electronic device, and may be used to shoot images within a certain area around the electronic device. The gas pressure sensor may be any type of barometric pressure sensor, such as a thin film type, a resistor type, and the like, and may be built-in or externally connected to the electronic device. The gas pressure sensor may be used to sense the change in gas pressure within a certain area around the electronic device. The electronic device of the exemplary embodiment may be an electronic screen, an electronic photo frame, a smart TV equipped with the camera and the gas pressure sensor, a mobile phone equipped with the gas pressure sensor, or the like.

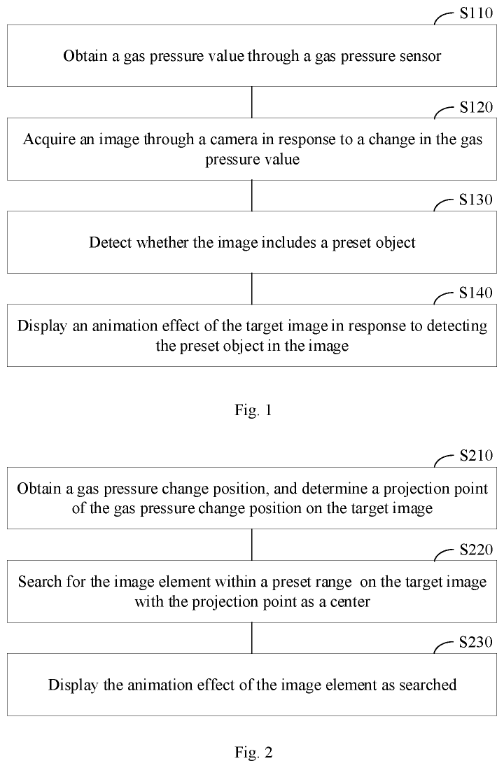

Before the method of the exemplary embodiment is started, a target image is displayed in the display device. The target image at this time may be a static image, which may be displayed on the display device in full screen, or may be displayed on a part of the display device, which is not limited in the disclosure. In the exemplary embodiment, when the static target image is displayed, an animation effect of the target image is displayed according to the user's interactional behavior (for example, the user blowing on the display screen) or a change in the environment. As shown in FIG. 1, which is a flowchart of the exemplary embodiment, the following steps S110 to S140 may be included:

In step S110, obtaining a gas pressure value through the gas pressure sensor.

The gas pressure sensor may be disposed at any position, usually located in an area where the user interacts more, such as a bezel position of the electronic screen, a position adjacent to a front camera of the mobile phone, and the like. After the gas pressure sensor is activated, it may detect the gas pressure value of the surrounding environment in real time or periodically. In the exemplary embodiment, for example, to enter the image display process of FIG. 1, the gas pressure sensor may be configured to be activated under certain conditions including: after opening the target image, the user selecting specific options, such as dynamic display options, exhibition function options, and the like, thereby triggering the activation of the gas pressure sensor; the user opening the target image through an application matched with the exemplary embodiment, thereby triggering the activation of the gas pressure sensor; automatically triggering the activation of the gas pressure sensor after the user opens the target image for a period of time without any further operation; or the like.

In step S120, acquiring images through the camera in response to the change in the gas pressure value.

The change in the gas pressure value refers to the detectable change due to external factors, other than the normal fluctuation of the gas pressure value. It may be determined by certain methods and standards. Two specific examples are provided below, but the following should not limit the scope of the disclosure:

(1) Determining whether the change in the gas pressure value within a preset time period reaches a preset threshold, specifically: the preset time period being to, the preset threshold being Pt, for each time the gas pressure sensor detecting the current gas pressure value, the current time being the end point, detecting the change in the gas pressure value within the time period tO, subtracting the minimum value from the maximum value of the gas pressure value, determining whether the difference reaches Pt, that is, whether Pmax−Pmin≥Pt is satisfied, and, if satisfied, the change in the gas pressure value being determined. The preset time period and the preset threshold may be set according to experience or actual application requirements. For example, the preset time period may be an interval time during which the gas pressure sensor periodically detects the gas pressure, and the preset threshold may be greater than the degree of fluctuation of the gas pressure value caused by normal ambient airflow.

(2) The preset threshold value being Pt, and a weight value k being set; the gas pressure sensor being activated, the gas pressure value initially detected being P0, and a reference gas pressure Pref=P0 being set; then the gas pressure value detected at a next moment being P1, determining whether |P1−Pref|≥Pt is satisfied, and if satisfied, the change in the gas pressure value being determined; updating the reference gas pressure by weighting, Pref=P1+(k−1)·Pref/k; and then the gas pressure value detected at a next moment being P2, determine whether |P2−Pref|≥Pt is satisfied, and updating Pref again, to perform cyclically.

If the change in the gas pressure value is determined, the camera is activated to automatically shoot images in order to determine whether the corresponding change has occurred in a shooting scene. In an alternative embodiment, the focal length of the camera may be adjusted automatically, and a plurality of images may be shot at different focal lengths; or when the camera may automatically adjust the position and angle (for example, the camera that may automatically rotate), a plurality of images may be further shot at different positions, angles, focal lengths, etc.

In step S130, detecting whether the images contain a preset object.

The preset object may refer to a target that may cause the change in the gas pressure value, and may include, for example, a human mouth or hand, a fan, and the like. The preset object may be determined according to application requirements. For example, in an interactive scene, if it is desired to present the effect of the user blowing or fanning with the hand to make the image dynamic, whether the images contain the human mouth can be detected. In an alternative embodiment, the detecting of the preset object may be performed by a deep learning routine or other deep learning technology, e.g., through a target detection model such as You Only Look Once (YOLO, an algorithm framework for real-time target detection, including multiple versions such as v1, v2, v3, and the like, any of which may be used in the present disclosure), Region-Convolutional Neural Network (R-CNN, or improved versions such as Fast R-CNN, Faster R-CNN, and the like), Single Shot MultiBox Detector (SSD), and the like.

In step S140, displaying the animation effect of the target image in response to detecting the preset object from the images.

The animation effect of the target image may be pre-configured, for example, the target image is a GIF dynamic image. Before step S140, the displayed target image may be a static image of the first frame, and a subsequent continuous frame animation is presented in step S140.

Based on the above, in the exemplary embodiment, after sensing the change in the ambient gas pressure through the gas pressure sensor, images are shot to detect whether the preset object such as a human mouth causing the change in the gas pressure exists. In the case where the preset object is detected, the animation effect of the target image is displayed. On one hand, there is provided an image display method with strong interaction sense, which enables users to control the animation display of images through operations such as blowing, and is more interesting and has a better user experience. On the other hand, setting the dual conditions of the change in gas pressure and shooting the preset object as a criterion for judging whether to display the image animation may reduce the influence of disturbances such as natural wind, the abnormal gas pressure sensor and the like, and improve the quality of interaction and practicability.

In an alternative embodiment, if the change in the gas pressure value is determined, a gas pressure change position may also be obtained, and an image of said position may be acquired by the camera. The gas pressure change position may be a position where the gas pressure sensor is located. Alternatively, the electronic device may be provided with a gas pressure sensor array for detecting gas pressure values at a plurality of positions, so that the gas pressure change position may be determined according to the changes in the gas pressure values at the plurality of positions. For example, the gas pressure sensor array is disposed on the back of the display screen. When the user blows air to a local area of the display screen, the gas pressure values detected by the gas pressure sensors change most noticeably in said area, and thus the gas pressure change position may be determined. A plurality of gas pressure sensors are arranged on a bezel of the electronic screen at intervals to form a rectangular array. When the gas pressure value changes, the gas pressure change position is calculated according to the change amount of the gas pressure value detected by each gas pressure sensor. After determining the gas pressure change position, the camera's shooting angle and the like is adjusted to make it shoot the image at said position, so that there is a greater probability of shooting users or other preset objects that cause the gas pressure change, thereby reducing the situation of missed shots and providing accurate detection.

In an alternative embodiment, the gas pressure change position may be the focal and, at this time, the shot image of the gas pressure change position is the clearest.

Further, a depth camera such as Time Of Flight (TOF) camera, a binocular camera, and the like may be disposed on the electronic device. The image may be shot by the following steps:

placing the gas pressure change position in a shooting range of the depth camera, and obtaining camera coordinates of the gas pressure change position in the depth camera;

adjusting a focal length of the depth camera until that a world coordinate of the gas pressure change position converted from the camera coordinate conforms to the gas pressure change position detected by the gas pressure sensor; and

shooting the image by the depth camera at this time.

The camera coordinates can refer to coordinates in the camera coordinate system, and the world coordinates refer to coordinates in the real world. The above steps will be described in greater detail below taking a binocular camera as an example:

after determining the gas pressure change position, obtaining the coordinates in the world coordinate system of the gas pressure change position, indicated as P_{rw}(X_{rw}, Y_{rw}, Z_{rw}), which being the coordinates obtained by the detection result of the gas pressure sensor;

adjusting the camera to place the gas pressure change position in the shooting range, preferably in the center of the shooting range (wherein the gas pressure change position may be relatively blurred without adjusting the focus distance), obtaining the external parameters of the camera relative to the world coordinate system at this time, including a rotation matrix R and translation matrix t;

shooting an image, the pixel coordinate of the gas pressure change position in the image being (uᵢ, vᵢ), and obtaining the camera depth data Zᵢ corresponding to the pixel coordinate of the position by solving the parallax of the binocular camera;

according to a pinhole camera model, obtaining the three-dimensional coordinates P_{ic}(X_{ic}, Y_{ic}, Z_{ic}) of the gas pressure change position in the camera coordinate system as follows:

$${Z}_{i} ( \begin{matrix}{u}_{i} \\ {v}_{i} \\ 1\end{matrix} ) = ( \begin{matrix}{f}_{x} & 0 & {c}_{x} \\ 0 & {f}_{y} & {c}_{y} \\ 0 & 0 & 1\end{matrix} ) ( \begin{matrix}{X}_{i c} \\ {Y}_{i c} \\ {Z}_{i c}\end{matrix} ) ;$$

where fx and fy are the parameters representing the focal length, generally, fx and fy are equal, and cx and cy are the main point coordinates (relative to the imaging plane);

according to the external parameters of the camera, obtaining the coordinates P_{iw}(X_{iw}, Y_{iw}, Z_{iw}) in the world coordinate system corresponding to the three-dimensional coordinates P_{ic} (X_{ic}, Y_{ic}, Z_{ic}) in the camera coordinate system as follows:

P_{ic}=RP_{iw}+t; and

comparing P_{iw} and P_{rw}, adjusting the focal length fx and fy if existing a deviation (generally in the Z coordinate), until P_{iw} and P_{rw} being consistent, at this time, the focus of the camera being at the gas pressure change position, and the final image being shot.

In an alternative embodiment, image elements may be extracted from the target image in advance, and the animation effects of respective image elements may be obtained to obtain the animation effect of the target image. The image elements refer to independent objects in the image, such as people, animals, plants, buildings, and the like, in the image. The content of the image elements may be processed, for example, by searching for the dynamic images of the image elements from the Internet; or performing process such as transforming, moving, rendering, changing color, and the like, on the original image elements in the target image, to generate a series of animation effects.

Further, the animation effect of the target image may be configured through the following steps:

using a target detection algorithm such as YOLO, R-CNN, and the like to classify the content of the target image, and identifying the image elements;

segmenting image elements from the target image, and storing the remaining part as the background of the target image; and

storing the animation effects of respective image elements, respectively.

The animation effects of respective image elements and the background, which may be used separately, together constitute an animation configuration file of the target image. For example, different frame animations of respective image elements can be combined with the background, or a portion of the image elements kept static, thereby obtaining more diverse animation effects.

Based on the method of extracting image elements from the target image and configuring animation effects separately, further, referring to FIG. 2, the animation effects may be displayed by the following steps S210˜S230:

In step S210, obtaining the gas pressure change position, and determining a projection point of the gas pressure change position on the target image;

In step S220, searching for the image elements within a preset range with the projection point as a center on the target image; and

In step S230, displaying the animation effects of the found image elements.

The method for obtaining the gas pressure change position is as described above, and will not be repeated herein. The projection point of the gas pressure change position on the target image may include: a vertical projection point of the gas pressure change position to the target image (that is, the display screen plane); or a point obtained by projecting the gas pressure change position to the target image in a gas flow direction, which is detected by the gas pressure sensor array. On the target image, the preset range is demarcated with the projection point as a center, usually a circle. Understandably, it may also have a rectangle shape or other shapes. The image elements are searched within the range, and the corresponding animation effect are displayed. For example, if there is a bird in the preset range, the animation effect of the bird is displayed. If there is a bird and a tree in the preset range, the animation effects of the bird and the tree are displayed at the same time. In this way, the effect of “where to blow, where to move” may be realized by the user, and the interactive interest may be further improved.

The size of the preset range may be set according to experience or actual application requirements. In an alternative embodiment, the size of the preset range may be determined according to the degree of change in the gas pressure value. Generally, the greater the change in the gas pressure value, the larger the preset range. For example, R=a·ΔP, wherein R is the radius of the preset range having the circle shape, a is a coefficient preset according to experience, and ΔP is the amount of the change in the gas pressure value.

In an alternative embodiment, the position of the preset object in the images shot by the camera may be projected onto the target image, and the image elements may be searched within a preset range around the projection point to display the corresponding animation effects.

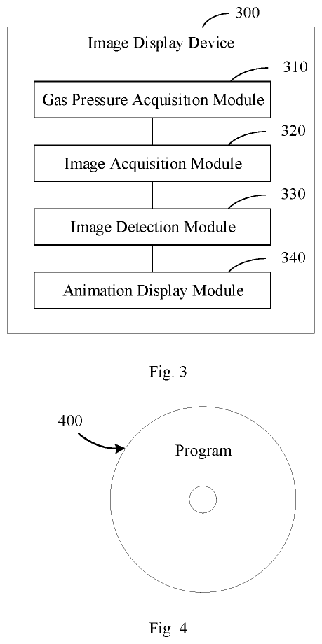

Exemplary embodiments of the present disclosure further provide an image display device applied to an electronic device. The electronic device includes a display device, a camera, and a gas pressure sensor, and the display device displays a target image. As shown in FIG. 3, the image display device 300 may include: an gas pressure acquisition module 310 for obtaining a gas pressure value through the gas pressure sensor; an image acquisition module 320 for acquiring images through the camera in response to change in the gas pressure value; an image detection module 330 for detecting whether the images contain a preset object; and an animation display module 340 for displaying an animation effect of the target image in response to detecting the preset object from the images.

In an alternative embodiment, the image acquisition module 320 may be used to acquire images through the camera in response to the change in the gas pressure value within a preset time period reaching a preset threshold.

In an alternative embodiment, the gas pressure acquisition module 310 may further be used to acquire a gas pressure change position, and the image acquisition module 320 may be used for acquiring an image of the gas pressure change position by the camera.

In an alternative embodiment, the image acquisition module 320 may further be used to shoot the image by the camera with the gas pressure change position as the focus.

In an alternative embodiment, the above-mentioned camera may be a depth camera. The image acquisition module 320 may include: a camera coordinate acquisition unit (not shown in the drawing) for placing the gas pressure change position in a shooting range of the depth camera, and obtaining camera coordinates of the gas pressure change position in the depth camera; a world coordinate matching unit (not shown in the drawing) for adjusting a focal length of the depth camera until that a world coordinate of the gas pressure change position converted from the camera coordinate conforms to the gas pressure change position detected by the gas pressure sensor; and an image shooting unit (not shown in the drawing) for shooting images through the depth camera.

In an alternative embodiment, the image display device 300 may further include: an animation configuration module (not shown in the drawing) for extracting image elements from the target image and obtaining animation effects of the respective image elements, thereby obtaining the animation effect of the target image.

In an alternative embodiment, the animation configuration module may include: an image element recognition unit (not shown in the drawing) for identifying the image elements from the target image through a target detection algorithm; a target image segmentation unit (not shown in the drawing) for segmenting the image elements from the target image, and store the remaining part as the background of the target image; and an animation effect storage unit (not shown in the drawing) for obtaining and respectively storing the animation effect of the image elements.

In an alternative embodiment, the gas pressure acquisition module 310 may further be used to obtain the gas pressure change position, and the animation display module 340 may further be used to determine a projection point of the gas pressure change position on the target image, search for the image elements within a preset range with the projection point as a center on the target image, and display the animation effects of the found image elements.

In an alternative embodiment, the above projection point may be a vertical projection point of the gas pressure change position to the target image.

In an alternative embodiment, the gas pressure sensor may include a gas pressure sensor array for detecting gas pressure values at a plurality of positions; and the gas pressure acquisition module 310 may further be used to determine the gas pressure change position according to the changes in the gas pressure values at the plurality of positions.

In an alternative embodiment, the preset object may include a human mouth.

The specific details of the modules/units of the above device have been described in detail in the embodiments of the method part. For the details of the undisclosed solution, please refer to the content of the method part, so they are not repeated herein.

Those skilled in the art may understand that various aspects of the present disclosure may be implemented as a system, method, or program product. Therefore, various aspects of the present disclosure may be specifically implemented in the form of a complete hardware implementation, a complete software implementation (including firmware, microcode, and the like), or a combination of hardware and software implementations, which may be collectively referred to herein as “circuit,” “module,” or “system.”

Exemplary embodiments of the present disclosure further provide a non-transitory computer-readable storage medium on which a program product capable of implementing the above-described method in the specification is stored. In some possible embodiments, various aspects of the present disclosure may also be implemented in the form of a program product, which includes program code and/or program instructions, and when the program product runs on the terminal device, the program code and/or program instructions is used to cause the terminal device to perform the steps according to various exemplary embodiments of the present disclosure described in an example method section of the specification.

Referring to FIG. 4, a program product 400 for implementing the above method according to an exemplary embodiment of the present disclosure is described, and the program product may adopt a portable compact disk read-only memory (CD-ROM), that includes program codes, and runs on a terminal device, such as a personal computer. However, the program product of the present disclosure is not limited thereto, and in the disclosure, the readable storage medium may be any tangible medium containing or storing a program, which may be used by or in combination with an instruction execution system, apparatus, or device.

The program product may use any combination of one or more readable media. The readable medium may be a readable signal medium or a readable storage medium. The readable storage medium may be, for example but not limited to, an electrical, magnetic, optical, electromagnetic, infrared, or semiconductor system, apparatus, or device, or any combination thereof. More specific examples of readable storage media (non-exhaustive list) include electrical connections with one or more wires, portable disks, hard disks, random access memory (RAM), read only memory (ROM), erasable programmable read-only memory (EPROM or flash memory), optical fiber, portable compact disk read-only memory (CD-ROM), optical storage device, magnetic storage device, or any suitable combination thereof.

The computer-readable signal medium may include a data signal that is transmitted in baseband or as part of a carrier wave, in which readable program code is carried. This propagated data signal may take many forms, including but not limited to electromagnetic signals, optical signals, or any suitable combination thereof. The readable signal medium may also be any readable medium other than the readable storage medium, and the readable medium may send, propagate, or transmit a program for use by or in combination with an instruction execution system, apparatus, or device.

The program code contained on the readable medium may be transmitted using any appropriate medium, including but not limited to wireless, wired, optical fiber cable, RF, or the like, or any suitable combination thereof.

Program code for performing the operations of the present disclosure may be written in any combination of one or more programming languages. The programming languages include object-oriented programming languages such as Java, C++, and the like, as well as conventional procedural programming languages such as “C” language or similar programming languages. The program code may be executed entirely on the user's computing device, partly on the user's device, as an independent software package, partly on the user's computing device and partly on a remote computing device, or entirely on the remote computing device or server. In situations involving remote computing devices, the remote computing device may be connected to the user computing device through any kind of network, including a local area network (LAN) or a wide area network (WAN), or may be connected to an external computing device (for example, using Internet service provision Business to connect via the Internet).

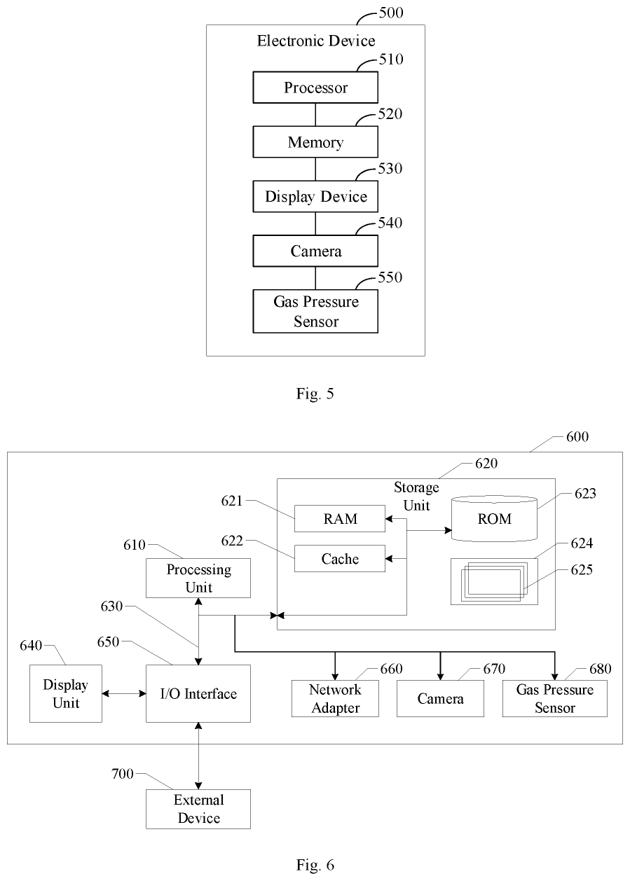

Exemplary embodiments of the disclosure further provide an electronic device capable of implementing the above method. As shown in FIG. 5, the electronic device 500 may include: a processor 510, a memory 520, a display device 530, a camera 540, and a gas pressure sensor 550. The memory 520 is for storing executable instructions of the processor 510; the display device 530 is for displaying a target image; and the processor 510 is configured to execute any of the image display methods of the present disclosure by executing the executable instructions, so as to display an animation effect of the target image.

In an alternative embodiment, the electronic device may be embodied in the form of a general-purpose computing device. As shown in FIG. 6, the components of the electronic device 600 may include but are not limited to: at least one processing unit 610, at least one storage unit 620, a bus 630 for connecting different system components (including the storage unit 620 and the processing unit 610), a display unit 640, a camera 670 and a gas pressure sensor 680.

The storage unit 620 stores a program code, which may be executed by the processing unit 610, such that the processing unit 610 executes the steps according to various exemplary embodiments of the present disclosure described in the above “exemplary method” section of the specification. For example, the processing unit 610 may execute the method steps shown in FIG. 1 or 2 and the like.

The storage unit 620 may include a readable medium in the form of a volatile storage unit, such as a random access storage unit (RAM) 621 and/or a cache storage unit 622, and may further include a read-only storage unit (ROM) 623.

The storage unit 620 may further include a program/utility tool 624 having a set of (at least one) program modules 625. Such program modules 625 include but are not limited to: an operating system, one or more application programs, other program modules, and program data. Each of these examples or some combination may include an implementation of the network environment.

The bus 630 may represent one or more of several types of bus structures, including a storage unit bus or a storage unit controller, a peripheral bus, a graphics acceleration port, a processing unit, or a local bus using any of various bus structures.

The electronic device 600 may also communicate with one or more external devices 700 (for example, keyboard, pointing device, Bluetooth device, and the like), may also communicate with one or more devices that enable a user to interact with the electronic device 600, and/or may communicate with any devices (for example, a router, modem, and the like) that enable the electronic device 600 to communicate with one or more other computing devices. Such communication may be performed through an input/output (I/O) interface 650. Moreover, the electronic device 600 may also communicate with one or more networks (such as a local area network (LAN), a wide area network (WAN), and/or a public network, such as the Internet) through a network adapter 660. As shown, the network adapter 660 communicates with other modules of the electronic device 600 through the bus 630. It should be understood that although not shown in the drawing, other hardware and/or software modules may be used in conjunction with the electronic device 600, including but not limited to: microcode, device driver, redundant processing unit, external disk drive array, RAID system, tape driver, data backup storage system, and the like.

Through the description of the above embodiments, those skilled in the art can easily understand that the example embodiments described herein may be implemented by software, or may be implemented by software in combination with necessary hardware. Therefore, the technical solutions according to the embodiments of the present disclosure may be embodied in the form of a software product, which can be stored in a non-volatile storage medium (which may be a CD-ROM, U disk, mobile hard disk, and the like) or on a network, including several instructions to cause a computing device (which may be a personal computer, server, terminal device, network device, or the like) to perform the method according to the exemplary embodiment of the present disclosure.

Further, the above-mentioned drawings are only schematic illustrations of processes included in the method according to the exemplary embodiment of the present disclosure, and are not intended to limit the purpose. It is understood that the processes shown in the above drawings do not indicate or limit the chronological order of these processes. In addition, it is also understood that these processes may be performed synchronously or asynchronously in, for example, multiple modules.

It should be noted that although several modules or units of the device for action execution are mentioned in the above detailed description, this division is not mandatory. In fact, according to the exemplary embodiments of the present disclosure, the features and functions of the two or more modules or units described above may be embodied in one module or unit. Conversely, the features and functions of one module or unit described above may be further divided into multiple modules or units to be embodied.

Those skilled in the art will readily contemplate other embodiments of the present disclosure after considering the specification and practicing the invention disclosed herein. This application is intended to cover any variations, uses, or adaptations of the present disclosure that conform to the general principles of the disclosure and include the common general knowledge or conventional technical means in the technical field not disclosed by the disclosure. It is intended that the specification and examples be considered as exemplary only, with a true scope and spirit of the disclosure being indicated by the appended claims.

It should be understood that the present disclosure is not limited to the precise structure that has been described above and shown in the drawings, and various modifications and changes can be made without departing from the scope thereof. The scope of the present disclosure is limited only by the appended claims.

What is claimed is:

1. An image display method applied to an electronic device, comprising:
providing the electronic device, the electronic device comprising a display device, a camera, and a gas pressure sensor, wherein the display device is configured to display a target image;
obtaining a gas pressure value through the gas pressure sensor;
acquiring an image through the camera in response to a change in the gas pressure value;
detecting whether the image includes a preset object; and
displaying an animation effect of the target image in response to detecting the preset object in the image.

2. The method according to claim 1, wherein the acquiring of the image through the camera in response to a change in the gas pressure value comprises: acquiring the image through the camera in response to the change in the gas pressure value being within a preset time period reaching a preset threshold.

3. The method according to claim 1, wherein the acquiring of the image through the camera comprises: obtaining a gas pressure change position, and acquiring an image of the gas pressure change position through the camera.

4. The method according to claim 3, wherein the acquiring of the image of the gas pressure change position through the camera comprises: shooting the image through the camera with the gas pressure change position as the focus.

5. The method according to claim 4, wherein:
the camera comprises a depth camera; and
the shooting of the image through the camera with the gas pressure change position as the focus comprises:
placing the gas pressure change position in a shooting range of the depth camera;
obtaining a camera coordinate of the gas pressure change position in the depth camera;
adjusting a focal length of the depth camera until a world coordinate of the gas pressure change position converted from the camera coordinate conforms to the gas pressure change position detected by the gas pressure sensor; and
shooting the image through the depth camera.

6. The method according to claim 1, further comprising: extracting an image element from the target image, and obtaining an animation effect of the image element, thereby obtaining the animation effect of the target image.

7. The method according to claim 6, wherein the extracting of the image element from the target image, and obtaining the animation effect of the image element, thereby obtaining the animation effect of the target image comprises:
identifying the image element in the target image based on a target detection algorithm;
segmenting the image element from the target image, and storing a remaining part as a background of the target image; and
obtaining the animation effect of the image element for separate storage.

8. The method according to claim 7, wherein the displaying of the animation effect of the target image comprises:
obtaining a gas pressure change position, and determining a projection point of the gas pressure change position on the target image;
searching for the image element within a preset range on the target image with the projection point as a center; and
displaying the animation effect of the image element as searched.

9. The method according to claim 3, wherein:
the gas pressure sensor comprises a gas pressure sensor array for detecting gas pressure values at a plurality of positions; and
the obtaining the gas pressure change position comprises: determining the gas pressure change position according to changes in the gas pressure values at a plurality of positions.

10. The method according to claim 1, wherein the preset object comprises a human mouth.

11. An electronic device comprising:
at least one hardware processor and memory;
program instructions executable by the at least one hardware processor stored in the memory;
a display device configured to display a target image;
a camera; and
a gas pressure sensor;
wherein the at least one hardware processor, when executing the program instructions, is directed to:
obtain a gas pressure value through the gas pressure sensor;
acquire an image through the camera in response to a change in the gas pressure value;
detect whether the image includes a preset object; and
display an animation effect of the target image through the display device in response to detecting the preset object in the image.

12. The electronic device according to claim 11, wherein the at least one hardware processor is further directed to: acquire the image through the camera in response to that the change in the gas pressure value within a preset time period reaches a preset threshold.

13. The electronic device according to claim 11, wherein the at least one hardware processor is further directed to: obtain a gas pressure change position, and acquire an image of the gas pressure change position through the camera.

14. The electronic device according to claim 13, wherein the at least one hardware processor is further directed to: shoot the image through the camera with the gas pressure change position as the focus.

15. The electronic device according to claim 14, wherein:
the camera comprises a depth camera; and
the at least one hardware processor is further directed to:
place the gas pressure change position in a shooting range of the depth camera;
obtain a camera coordinate of the gas pressure change position in the depth camera;
adjust a focal length of the depth camera until a world coordinate of the gas pressure change position converted from the camera coordinate conforms to the gas pressure change position detected by the gas pressure sensor; and
shoot the image through the depth camera.

16. The electronic device according to claim 11, the at least one hardware processor is further directed to: extract an image element from the target image, and obtain an animation effect of the image element, thereby obtaining the animation effect of the target image.

17. The electronic device according to claim 16, wherein the at least one hardware processor is further directed to:
identify the image element in the target image based on a target detection algorithm;
segment the image element from the target image;
store a remaining part as a background of the target image; and
obtain the animation effect of the image element for separate storage.

18. The electronic device according to claim 17, wherein the at least one hardware processor is further directed to:
obtain a gas pressure change position;
determine a projection point of the gas pressure change position on the target image;
search for the image element within a preset range on the target image with the projection point as a center; and
display the animation effect of the image element as searched through the display device.

19. The electronic device according to claim 13, wherein:
the gas pressure sensor comprises a gas pressure sensor array for detecting gas pressure values at a plurality of positions; and
the at least one hardware processor is further directed to: determine the gas pressure change position according to changes in the gas pressure values at a plurality of positions.

20. The electronic device according to claim 11, wherein the preset object comprises a human mouth.
